(19) United States
(12) Patent Application Publication
(10) Pub. No.: US 2002/0182904 A1
(43) Pub. Date: Dec. 5, 2002

(54) Cable connecting device

(76) Inventor: Wolfgang Peter Siebert, Tullinge (SE)

Correspondence Address: Nixon & Vanderhye, 8th Floor, 1100 North Glebe Road, Arlington, VA, 22201-4714, US

(21) Appl. No.: 10/148,272

(22) PCT Filed: Nov. 29, 2000
(86) PCT No.: PCT/SE00/02363

(30) Foreign Application Priority Data
Nov. 30, 1999 (SE) 9904357.2

(51) Int. Cl. H01R 4/58

(52) U.S. Cl. 439/86

(57) ABSTRACT

The present invention relates to a device (1) that can be used to connect a cable (10). The connector includes a contact matrix (3) and the cable includes electrical conductors (10a-10d). The matrix elements of the contact matrix (3through-passing channels (3a-3d) in which the conductors (10a-10d) have been placed and the ends of said conductors applied to the outlet ends (3oa-3od) of the channels. The conductor ends are each applied electrically to a contact receiving device through the medium of an electrically conductive and elastically resilient material.

### FIELD OF INVENTION

The present invention relates to a cable connecting device, and to a system that includes such a cable connecting device. The invention also relates to a method of fitting the cable to the connector.

### DESCRIPTION OF THE BACKGROUND ART

Electronic devices tend to become smaller and smaller in volume, at the same time as system solutions become successively larger. Large system solutions involve many cable connections, which means that the cable connections to said devices are also required to be of smaller size. Fibre optics is a solution that permits high signal transmission with only a few connections. One drawback with fibre optics, however, is that a Fibre optic transmission requires a laser to be used as a signal generator. A laser incurs a high cost and, moreover, has low efficiency since a large amount of the energy required by the laser is converted to heat. The problem is less pronounced in the case of conventional electric signal transmission. U.S. Pat. No. 5,947,752 teaches a cable connecting device that includes a holder-mounted electric contact device. A conventional cable that includes several electrical conductors is fitted by connecting the conductors to the electric contact device encapsulated in the holder and connected to a signal receiving device. One drawback with the solution taught by the U.S. patent specification resides in the length of mutually separated cable conductors required from the cable to the electric contact device in order to enable the conductors to be fitted to said device. The fact that the cables are free-laid means that the relative order of said cable conductors before being freed is disturbed. Impedance matching is impaired when the order of the cable conductors is disturbed, particularly in the case of twisted paired cables. Moreover, the risk of crosstalk increases when the cable conductors are too close together. Another drawback with the solution taught by the U.S. patent specification resides in the joining device to which the electric connecting device is joined between the cable conductors and a device that receives the connecting device. This intermediate matching device involves an additional signal transition and causes interference in the signal transmission between cable and receiving unit, which results in poorer impedance matching and signal quality, and also in crosstalk in the contact device. The U.S. Pat. No. 2,275,762 discloses a connector in which the ends of the cable conductors are applied directly to a contact-receiving device in the absence of joining means. One problem with the solution taught in this U.S. patent specification resides in poor contact qualities when fitting the connecting device to the device that receives said contact-receiving device This results in signal disturbances.

### SUMMARY OF THE INVENTION

The present invention addresses the problem of unfavorable impedance matching in a cable connecting device due to the presence of separated cable conductors between the cable and the connecting device.

The invention also addresses a further problem concerning the occurrence of signal disturbances in the cable connecting device as a result of the presence of an intermediate joining device between the cable and said receiving unit. Although the joining device provides assistance when fitting the cable connecting device to the receiving unit, it also causes signal disturbances at the same time.

These problems are solved in accordance with the invention with a cable connecting device that includes a non-conductive contact matrix whose matrix elements consist in through-passing channels. The cable conductors are placed in the channels and the non-insulated ends of the cable conductors are affixed to one end of the matrix with the aid of an electrically insulating fastener material. The output ends of the cable can then be connected electrically to a connector-receiving device in the receiving unit. The ends of the conductors are therewith each brought indirectly and mechanically into contact with the connector-receiving device through the medium of an electrically conductive and elastically resilient material in accordance with the invention.

More specifically, the problems are resolved by placing the mutually separated cable conductors into the matrix element of a contact matrix, such that the relative positions of said conductors in the matrix will correspond at least partially to the mutual positions of the conductor lengths still contained within the cable. Thus, the cable conductors are not distanced from one another and impedance matching in twisted twin cables will remain almost intact. According to the invention, when connecting the cable connecting device to receiving contact surfaces on the receiving unit, the cable conductors lie indirectly against the contact surfaces of the receiving unit via the electrically conductive resilient material.

The object of the present invention is flus to improve signal qualities in the transmission of signals from a cable to a receiving unit.

One advantage afforded by the invention is that impedance matching remains almost intact, even through the cable connecting device.

Another advantage is that the surface at the ends of the cable conductors are cleaned automatically by the movement and deformation of the intermediate resilient material that results from the pressure exerted when assembling the cable connecting device to the receiving unit.

A further advantage is that the signal distortion minimises the short signal path through the connector.

Yet another advantage resides in simplified assembly of cable and connector, resulting in greater economic gain.

Still another advantage resides in the fact that assembly can be automated and the reliability in assembly can be further enhanced and costs lowered at the same time.

The invention will now be described in more detail with reference to preferred embodiments thereof and also with reference to the accompanying drawings.

### BRIEF DESCRIPTION OF THE DRAWINGS

FIG. 1 illustrates a cable connecting device of an earlier known kind, and shows uncovered cable conductors and an intermediate device.

FIG. 2 illustrates an inventive cable connecting device and is a perspective, transparent view of a cable and a contact matrix in the cable connecting device.

FIG. 3 illustrates an inventive cable connecting device.

FIG. 4 is a flowchart describing assemblage of connecting device and cable.

FIG. 5 illustrates a contact plate between a connector and a connector-receiving unit.

### DESCRIPTION OF PREFERRED EMBODIMENTS

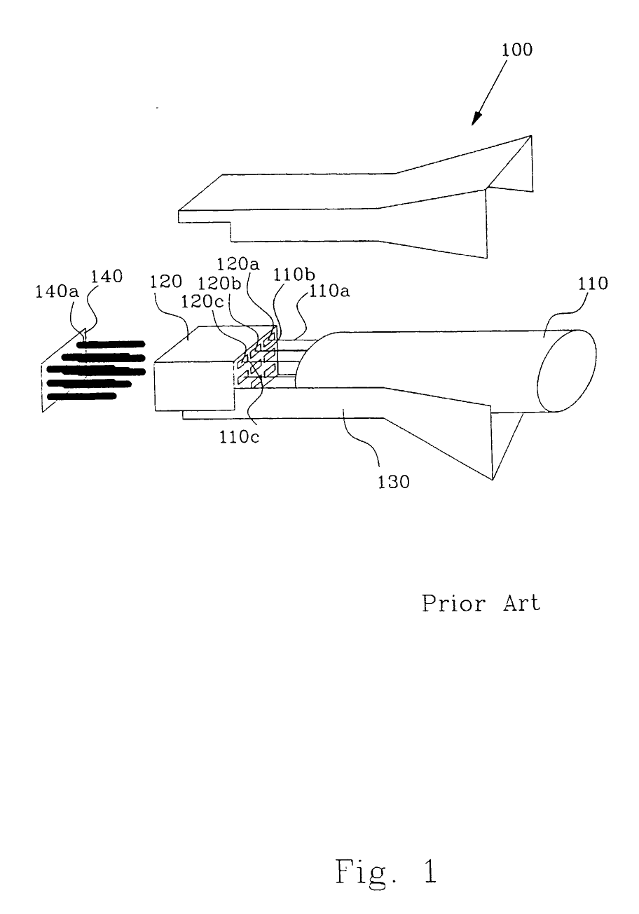

FIG. 1 illustrates an example of an earlier known cable connecting device 100. The prior art device includes a protective casing 120 and a conductor joining device 120 connected between a cable 110 and a unit 140 that receives said cable connecting device. The cable 110 includes electrical conductors 110a, 10b and 110c. The conductor joining device 120 includes electrically conductive connection forks or sleeves 120a, 120b and 120c which extend from an input side to an output side opposite to the input side of said device 120. The electric conductors 110a, 110b, 110c are connected to the connecting forks 120a, 120b, 120c of the device 120 on its input side. In order to be able to fit the cable conductors 110a, 110b, 110c to the connecting forks 120a, 120b, 120c, it is necessary for the cable 110 to be spaced from the conductor connecting device 120. In this respect, the separated or free-laid conductors are located in the air gap between cable and device. The distance required for fitting the conductors is in the order of 10-20 mm. The free-laid conductors cause both crosstalk and impaired impedance matching in twisted paired cables. The connecting forks on the opposite output side of the conductor joining device are fitted over the contact pins 140a in the receiving unit 140. The intermediate device 120 between the cable conductors 110a-110c and the receiving unit 140 contributes towards signal transmission.

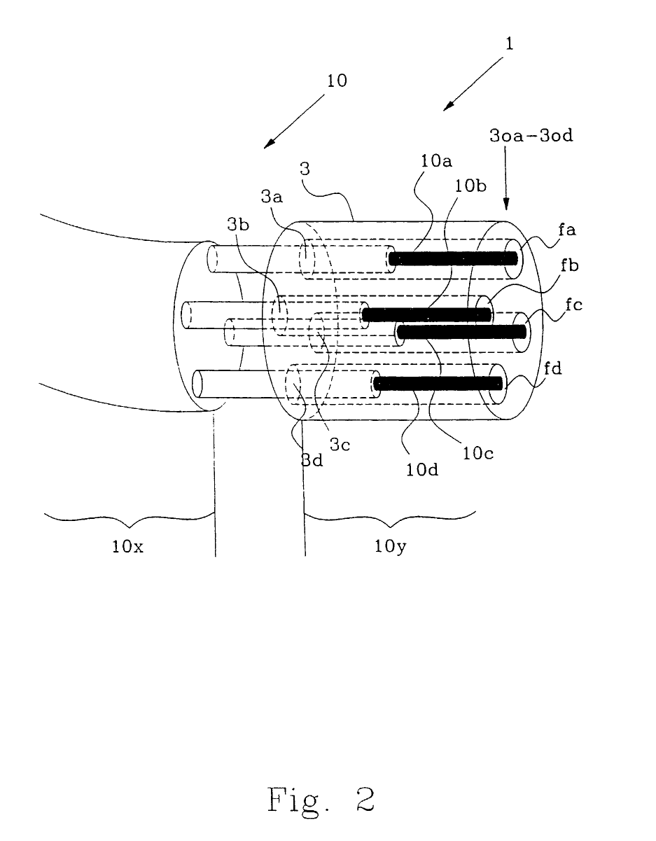

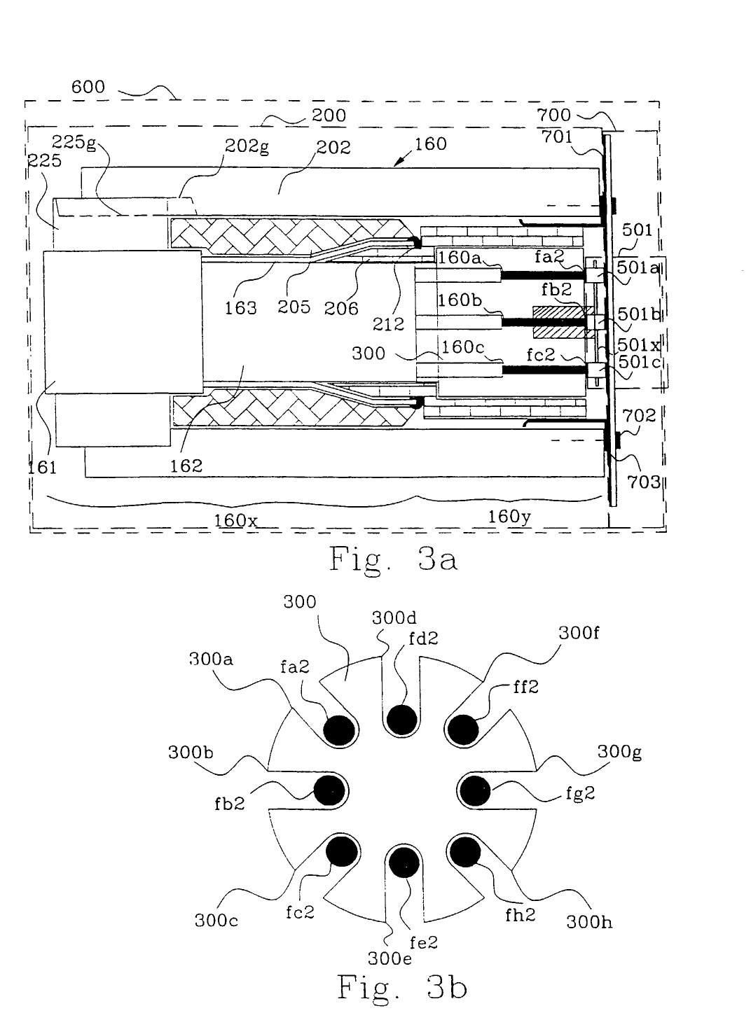

FIG. 2 illustrates a cable connecting device i constructed in accordance with the invention and shows the most relevant components of said device. Thus, in its simplest form, the device includes a contact matrix 3 made of plastic or some other insulating material. The contact matrix includes through-passing channels 3a, 3b, 3c, 3d, which in the illustrated case are tubular channels extending through the matrix 3. The channels may be slotted to ensure that the cable cab be fitted readily to the device. FIG. 3b illustrates an example of slotted channels, which will be explained in more detail further on. A cable 10 comprises conductors 10a, 10b, 10c and 10d. The cable is divided into two parts, a cable part 10x which includes cable conductors that are contained, i.e. enclosed, in the cable, and a conductor par: 10y which includes the separated or freed-laid conductors 10a-10d. Prior to being lain free, the conductors are contained in a protective casing in said cable part. When fitting the cable connecting device, the covering or sheathing around the cable is shortened and :he conductors freed. Part of the insulation around the electric conductors 10a-10d is removed. That part of the conductors 10a-10d from which insulation has been removed is shown in a solid form. The conductors 10a-10d are inserted through channel inlets 3a, 3b, 3c and 3d and through the matrix channels and out through the channel outlet ends 3oa, 3ob, 3cc and 3od. The conductors are fastened with an electrically insulating glue applied inside the channels, whereafter the conductor ends fa-fd are cut-off flush with the outlet side so the matrix. The conductors are fastened so that the cable part 10x and the matrix 3 will only be a short distance apart, and so that the length of the uncovered part of the cable conductors has been minimised. The distance between the matrix and the cable is only some few millimeters, although this distance has been enlarged in the Figure for the sake of illustration. The cable connecting device 1 is connected to a receiving unit via an intermediate device (not shown in this Figure). This is effected by bring the ends fa-fd of respective conductors into firm contact with corresponding contact points on the receiving unit, through the medium of a elastically resilient material. The intermediate device is comprised of electrically conductive, resilient contact points that are insulated electrically from one another. The resilient contact points combine each of the cable conductors with a corresponding contact point on the receiving unit. The intermediate device, which is not shown in FIG. 2, will be described in more detail below with reference to FIG. 3a.

FIG. 3a illustrates an inventive system that includes a cable 160, a cable connecting device 200, and a receiving unit 700 to which the cable connecting device 200 has been connected. The cable connecting device 20C includes an electric contact matrix 300 of a type similar to that earlier described with reference to FIG. 2. Figure is a cross-sectional view of the contact matrix 300. The contact matrix includes a total of eight slotted channels 300a--300h in which insulated conductors 160a-160h have been placed. The cable 160 includes a total of eight insulated conductors 160a-160h, of which only three conductors 160a, 160b, 160c are seen in FIG. 3a. The conductors have been partially freed from the cable and placed in the contact matrix. That part of the cable in which conductor lengths are still contained in the cable sheathing is hereinafter referred to as cable part 160x, while that part of the cable in which the conductors have been separated is referred to as conductor part 160y. The cable conductor 160a is shown placed in the channel 300a, whereas the conductor 160b is shown placed in the channel 300b and the conductor 160c has been shown placed in the channel 300c, and so on. Electrically insulating glue is applied in the through-passing channels of the matrix. The conductors are then cut-off flush with the end surface of the matrix. The end points of the conductors, the fastener glue, and the matrix are then ground or worked at right angles to the cylindrical surface of the outer sleeve 205, so as to obtain electrical contact points for each cable conductor The cable 160 includes a conductive inner casing 162, for instance an aluminium casing, around the cable conductors 160a, 160b, 160c whilst said conductors are contained within the cable 160 in the cable part 160x. An earth braiding 163 comprised of an electrically conductive material is formed as a network of thin wires or filaments that embraces the conductive inner casing of the cable 160. The earth braiding 163 is embraced by an outer covering 161 of insulating material, within the cable 160. The cable connecting device 200 includes an inner sleeve 206 and an outer sleeve 205. The inner and outer sleeves are used to establish reliable contact between the earth braiding 163 and an earth plane on the receiving unit 700, through the medium of a contact spring 703. The earth braiding 163 is fastened between the inner and the outer sleeve, as explained in more detail further on. The cable connecting device 200 includes a sleeve 202 that embraces the cable and those parts of the contact device 200 mentioned hitherto, and the contact spring 703. The cable connecting device 200 also includes an electrically conductive and elastically resilient contact plate 501. The contact plate is fastened to the contact matrix 300 and in the illustrated embodiment includes a total of eight contact points 501a-501h which are insulated from one another with the aid of an insulated plate 501x. Of the eight contact points mentioned, three contact points 501a, 501b and 501c are shown in FIG. 3a. The contact points 501a-501h are brought into firm contact with corresponding contact points fa2-fh2 o the cable connecting device, of which only three contact points fa2-fc2 are shown in FIG. 3a. The firm contact between the contact points 501a-501h and fa2-fh2 is achieved with the aid of a tightening means. The tightening means includes a nut 225 whose threads 225g mesh with corresponding threads 2029 in the sleeve 202 and which functions to press the contact points 501a-501h and fa2-fh2 against one another and against corresponding contact points on the receiving unit 700. The tightening means will be described in more detail further on. The resilient contact plate 501 creates uniform pressure distribution between the end points of the cable conductors and the signal receiving unit, which may be a circuit board for instance. When the ends of the cable conductors are applied to the contact plate 501 under pressure, as evident from FIG. 3, the end surfaces of the conductors will be cleaned as a result of the movement that occurs in said tightening process.

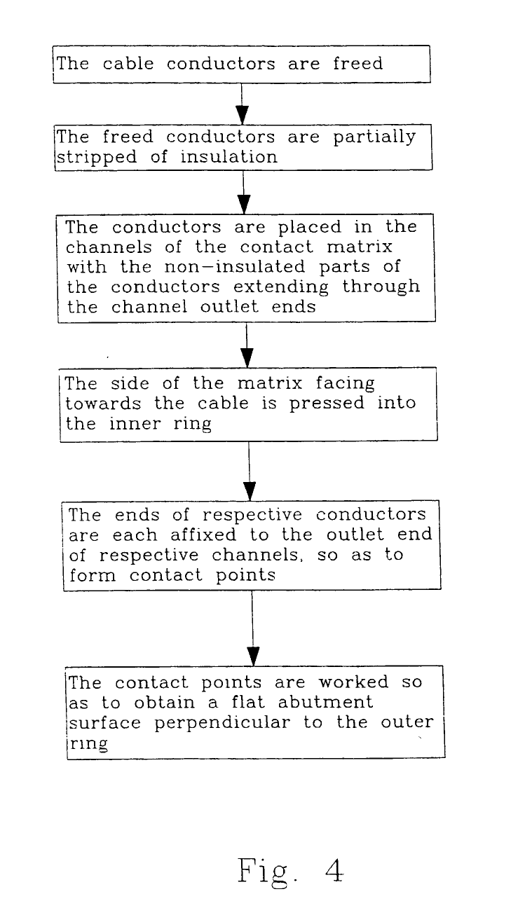

A method of fitting the cable to the cable connecting device will now be described with reference to the flowchart of FIG. 4. The flowchart includes only the most essential method steps. The description of the method and the flowchart are intended to be read together with FIG. 3. The method illustrates a way of fitting the cable 160 in the cable connecting device 200 in accordance with the invention, and comprises the following method steps:

A portion of the insulating outer casing 161 is removed from the cable at a distance of about 5 cm from the end of the cable, so as to expose the earth braiding.

The earth braiding 163 and the conductive inner casing 162 are removed at a distance of about 3.4 cm from the end of the cable, so as to separate the conductors 160a-160h. Only the conductors 160a-160c are visible in FIG. 3a.

The nut 225 is threaded over the cable and passed beyond the part from which the outer casing 161 has been removed.

The outer sleeve 205 is threaded over the cable, so as to partially embrace the insulating outer casing 161, while the remaining part of the sleeve embraces a par of the exposed earth braiding 163.

Part of the insulation is removed from the freed conductors 160a-160h, so that said conductors will include an insulated Tart and an intermediate tart from which insulating has been removed. This is achieved by cutting through the insulation and drawing said insulation forwards over a short distance, so as to form an outer insulated part. This insulated outer part is removed further on in the process. This outer part is not shown in FIG. 3. The parts of the conductors 160a-160c from which insulation has been removed are shown as solids in the Figure.

The inner sleeve 206 is threaded over the cable and over the conductive inner casing 162, so that the inner casing will be located partly beneath both the outer sleeve 205 and the earth braiding 163. Part of the inner sleeve extending beyond the outer sleeve 205 extends over the cable conductors 160a-160h.

The earth braiding pressed between the outer sleeve 205 and the inner sleeve 206 is fastened between the inner and the outer sleeve with the aid of tin solder 212 or conductive glue.

All of the eight cable conductors 160a-160h are placed in respective slotted channels 300a-300h in the contact matrix 300 The insulated parts of the conductors extend in the matrix channels roughly to half the length of the matrix, when the matrix has been pushed into the inner sleeve. The bare or non-insulated parts of the conductors extend from the output ends of the eight slotted channels 300a-300h in the contact matrix. The remaining outer insulated part is also located outside the contact matrix. The various conductors can be identified by the respective colours of the aforesaid outwardly protruding insulation cut from the conductors.

The contact matrix is pushed into the inner sleeve 206

The naked parts of the cable conductors 160a-160h extending out from the eight slotted channels of the contact matrix are each affixed to the outlet end of respective channels with the aid of an electrically insulating glue. The conductor 160a is fastened to the outlet end of channel 300a, the conductor 160b is fastened to the outlet end of channel 300b, and so on until all conductors 160a-160h have been fastened to he outlet ends 300a-300h of respective channels, such as to form eight contact points fa2-fh2 at the end of the matrix distal from the cable, when said end is cut-off and worked. The contact points fa2-fh2, the contact matrix 300 and the glue are worked to obtain a flat abutment surface perpendicular to the outer sleeve 205.

The outer sleeve 202 is mounted together with the contact spring 703 against an earth plane 701 on the receiving unit 700. The outer casing 202 and the contact spring are fitted to the earth plane 701 by means of a screw device 702.

The contact matrix 300 and that part of the cable end connected to said contact matrix and the cuter and inner ring are placed in the outer casing 202 together with the contact plate 501. The contact spring 703 lies against the inner sleeve 206 so as to obtain contact between the contact spring 703 and the inner sleeve. The contact spring extends along the inner sleeve, so as to obtain electric contact between the inner sleeve and the earth plane 701 of the receiving unit 700.

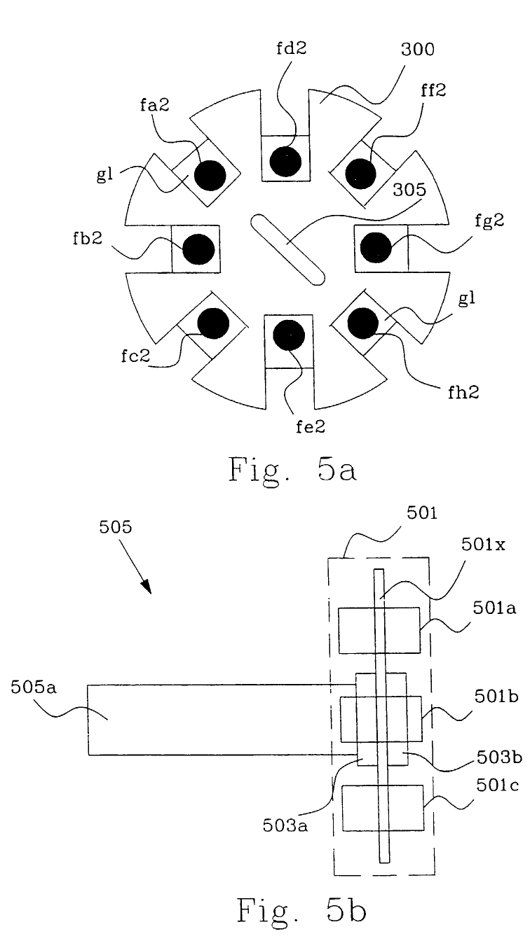

The threads 225g on the nut 225 are screwed into the threads 202g of the sleeve 202, so as to generate a pressure force between the contact points fa2-fh2 on the cable connecting device and the contact points 501a-501h on the contact plate 501. Contact is achieved with the outer sleeve 205, when the nut is screwed into the sleeve. Tightening of the nut results in further pressure of the contact points fa2-fh2 against the contact points 50la-501h on the contact plate 501, these outer points being pressed, in turn, against contact points on the receiving unit. The contact points are drawn against one another until a force of 0.5N is reached. Spacing shoulders 503a and 503b enable the force 0.5N to be achieved on the contact surfaces, while any surplus or excess force is taken up by the spacer shoulders. This will be explained in more detail with reference to FIG. 5.

FIG. 5 illustrates an arrangement by means of which contact points fa2-fh2 in the contact matrix 300 can be tightly connected with corresponding contact points in the contact plate 501 and further against the contacts on the receiving unit. FIG. 5a is a cross-sectional view of the contact matrix 300 and the matrix-carried contact points fa2-fh2. It will be apparent from FIG. 5a that glue has been applied to the through-passing channels of the matrix. This glue application has been referenced [symbol] in FIG. 5. The glue gl is applied around the cable conductors in all eight channels of the embodiment illustrated in FIG. 5a. The contact points fa2-fh2 have been worked parallel with the surface of the matrix distal from the cable, at right angles to the outer sleeve, so that when the contact plate 501 is in abutment with the contact matrix, it will also lie against the end points fa2-fh2 of the conductors, these latter end points being, for instance, coated with gold with an insulating layer of nickel therebetween. The contact matrix includes a grip hole 305. An intermediate device 505 is shown in FIG. 5b. This intermediate device includes the contact plate 501 previously mentioned with reference to FIG. 3a. The contact plate 501 includes eight contact points, of which only three contact points 501a-501c are shown in FIG. 5b. The intermediate device 505 also includes a projection 505a. The grip hole 305 in the contact matrix forms a space that accommodates the projection 505a on the intermediate device 505 when said projection is pressed into a corresponding profile in the contact matrix 300. Subsequent to having tightened the nut 225 and the sleeve 202, as previously described with reference to FIG. 3a, the eight contact points of the contact matrix will lie tightly against the eight contact points of the receiving unit with a force of, e.g., 0.5N. As the nut 225 is tightened, the contact matrix 300, the intermediate device 505, and the receiving unit 700 are pressed together. If the nut is tightened to an extent that causes the force to begin to exceed 0.5N, the excess force exerted by the nut will be taken up by the spacer shoulders 503a and 503b, in accordance with the embodiment. This enables the force applied to the end points of the cable connecting device to be regulated on the basis of the length of the spacer shoulders 503a, 503b.

It will be understood that the invention is not restricted to the aforedescribed embodiments. Conceivably, the contact matrix may have an appearance that differs from the appearance shown in the illustrated examples. Parts of the channels that form matrix elements in the contact matrix may be coated internally with an electrically conductive material and the cable conductors can then be fastened to said material with the aid of tin solder, for instance. It is also conceivable to fasten the conductors to the contact matrix n a manner in which said conductors will not protrude out from the fastener material, which must then be electrically conductive. The illustrated fastener element is only an example of a fastener element that can be used to enable contact points on the receiving unit to be brought into firm contact with the contact matrix. Instead of the receiving unit having the form of a circuit board, as indicated in the aforegoing, other types of signal receiving units are conceivable. For instance, the signal receiving unit may be another cable connecting device fastened to a cable and that cables can be joined together in this way. Thus, the invention is not restricted to the aforedescribed and illustrated embodiments thereof, since modifications can be made within the scope of the accompanying claims.

1. A cable connecting device (1; 200) which comprises a contact matrix (3; 300) and which cable (10; 160) includes electric conductors (10a-10d; 160a-160h), wherein matrix elements in the contact matrix (3; 300) include through-passing channels (3a-3d; 300a-300h) in which the conductors (10a-1d; 160a-160h) have been placed and the ends (fa-fd; fa2-fh2) of the conductors have been fastened to the channel outlet ends (3oa-3od) that lie distal from said cable characterised in that the cable ends (fa-fd; fa2-fh2) have been brought into firm electrical contact with a contact receiving device (700) through the medium of an electrically conductive and elastically resilient contact material (501).

2. A cable connecting device according to claim 1, wherein the contact receiving device is a circuit board.

3. A cable connecting device (1; 200) according to claim 1 or 2, wherein the ends of the cable conductors are applied Go the outlet ends (3oa-3od) of the channels such that the cable (10x, 160x) will lie close to the inlet ends of the channels (3a-3d; 300a-300h).

4. A cable connecting device (1; 200) according to any one of claims 1-3, wherein said channels are insulated electrically one from the other.

5. A cable connecting device (1; 200) according to any one of claims 1-4, wherein the ends (fa-fd) of the conductors have been worked with the surface of the contact matrix perpendicular to an outer sleeve (205).

6. A cable connecting device (200) according to any one of claims 1-5, wherein each of the channels (300a-300h) includes a longitudinal slot or slit.

7. A cable connecting device (200) according to any one of claims 1-6, wherein said device includes earth braiding (163) around the conductors (160a-160c) contained in the cable, the electrically conductive outer sleeve (205) embracing the earth braiding (163), and an electrically conductive inner sleeve (206) inwards of both the outer sleeve (205) and the earth braiding (163), such that the earth braiding (163) lies against both the outer sleeve (205) and the inner sleeve (206).

8. A cable connecting device (200) according to claim 7, wherein the earth braiding (163) is connected to the outer sleeve (205) and to the inner sleeve (206) through the medium of electrically conductive fastener material (212).

9. A cable connecting system (600) hat includes a connector (1; 200) according to any one of claims 1-8, wherein the system includes a unit (700) which receives the cable connecting device (1; 200) and which is connected to an electrically conductive and elastically resilient contact material (501) against which said cable connecting device (1; 200) are caused to lie so that the ends of the conductors (fa-fd; fa2-fh2) are connected electrically to corresponding contact points on the resilient contact material (501).

10. A connecting system according to claim 9 that includes a fastener element (225) with which the contact material (501), the contact points (501a-501c) and the ends (160a-160c) of said conductors are brought into firm contact with one another.

11. A method of connecting a cable (10; 160) to a cable connecting device (1; 200), wherein said cable includes on the one hand a cable section (10x; 160x) in which cable conductors are enclosed by the cable sheathing and on the other hand a cable section (10y; 160y) in which the conductors (10a-10d; 160a-160h) are lain free, and wherein the cable connecting device (1) includes a contact matrix (3; 300) having matrix elements (3a-3d; 300a-300h), and wherein the method is characterised by the steps of:
placing respective free-lain cable conductors (10a-10d; 160a-160h) in the matrix elements of the contact matrix;
connecting the electrically conductive ends (fa-fd; fa2-fh2) of the cable conductors to the outlet end of respective matrix elements that lie distal from the cable section (10x; 160x) with the aid of an electrically insulating fastener material (gl);

12. A method of connecting a cable (10; 160) to a cable connecting device (1; 200) in accordance with claim 11, wherein the method includes the further step of:
plane-working the fastener material and the outlet end of the contact matrix at right angles to the outer sleeve (205).

13. A method of connecting a cable (10; 160) to a cable connecting device (1; 200) in accordance with claim 12, comprising the further step of:
removing part of the insulation on the cable conductors so that outer insulated parts of said conductors will extend outwardly of the contact matrix when said conductors are fastened in matrix elements.
